(19) United States
(12) Patent Application Publication
(10) Pub. No.: US 2019/0026803 A1
(43) Pub. Date: Jan. 24, 2019

(54) DIGITAL CODE SERVER

(71) Applicant: Sony Interactive Entertainment LLC, San Mateo, CA (US)

(72) Inventors: Dawn Cindy De Guzman, San Mateo, CA (US); Mary Wilson, San Mateo, CA (US); Stephanie Lucas, San Mateo, CA (US); Daniel Kim, San Mateo, CA (US)

(21) Appl. No.: 15/654,959

(22) Filed: Jul. 20, 2017

(51) Int. Cl. G06Q 30/06; G06F 17/30

(52) U.S. Cl. CPC G06Q 30/0609; G06F 17/30371; G06Q 30/0185; G06F 17/3056; G06Q 30/0641; G06F 17/30312

(57) ABSTRACT

In one aspect, a system includes at least one digital code server (DCS) including at least one server processor and at least one server storage having instructions executable by the server processor. The system also includes at least one supplier computer system including at least one supplier processor and at least one supplier storage having instructions executable by the supplier processor, as well as at least one retailer computer system including at least one retailer processor and at least one retailer storage having instructions executable by the retailer processor. The supplier processor accessing the instructions on the supplier storage is configured to upload code information to the DCS. The retailer processor accessing the instructions on the retailer storage is configured to access the code information from the DCS and to provide codes according to the code information to buyers of products, with the products requiring input of respective codes by buyers to be fully enabled.

### FIELD

The application relates to systems and methods for a digital code server.

### BACKGROUND

Suppliers of technology-related products often sell their products through online and other marketplaces. However, instances of fraud and hacking are prevalent in these types of marketplaces. Therefore, a need has arisen to prevent such fraud and hacking while still allowing the supplier to make its products and associated services available to various retailers and ultimately consumers in as straightforward a manner as possible, even where the retailers might use different technology platforms with different requirements. There are currently no adequate solutions to the foregoing computer-related, technological problem.

### SUMMARY

Accordingly, in one aspect a system includes at least one digital code server (DCS) that includes at least one server processor and at least one server storage having instructions executable by the server processor. The system also includes at least one supplier computer system that includes at least one supplier processor and at least one supplier storage having instructions executable by the supplier processor. Still further, system includes at least one retailer computer system that includes at least one retailer processor and at least one retailer storage having instructions executable by the retailer processor. The supplier processor accessing the instructions on the supplier storage is configured to upload code information to the DCS, with the code information including information categorized by retailer identity and product type. The retailer processor accessing the instructions on the retailer storage is configured to access the code information from the DCS and to provide codes according to the code information to buyers of products, the products requiring input of respective codes by buyers to be fully enabled.

The code information may include, for each code, a product identification to which the code applies and a retailer to whom the code applies.

The supplier processor accessing the instructions on the supplier storage may be configured to upload to the DCS, for at least some codes, a standard release date and a pre-order release date. The server processor accessing the instructions on the server storage may be configured to prevent downloading, to the retailer computer system, at least one code prior to the respective standard release date and/or pre-order release date of the respective code.

The retailer processor accessing the instructions on the retailer storage may be configured to present, on at least one display of the retailer computer system, at least one user interface (UI) presenting plural product identifications and respective code data for at least some of the respective product identifications.

The server processor accessing the instructions on the server storage may be configured to access information related to sales velocity pertaining to a first retailer and a first product, access information related to a threshold pertaining to the first retailer and the first product, and determine, based at least in part on the sales velocity and threshold, whether to send an alert message to at least the supplier computer system.

The supplier processor accessing the instructions on the supplier storage may be configured to upload to the DCS at least one product update. The retailer processor accessing the instructions on the retailer storage may be configured to download from the DCS the product update and implement the product update on a respective product within a supplier-defined period.

The retailer processor accessing the instructions on the retailer storage may be configured to upload to the DCS at least one request for additional codes pertaining to at least a first product. The server processor accessing the instructions on the server storage may be configured to provide the request to the supplier computer system. The supplier processor accessing the instructions on the supplier storage may be configured to upload to the DCS codes according to the request.

The supplier processor accessing the instructions on the supplier storage may be configured to present, on at least one display of the supplier computer system, at least one user interface (UI). The UI may include, for at least one retailer, indication of unsold codes associated with pre-release products, indication of unsold codes associated with released products, indication of codes sold on demand, indication of codes sold in bulk, and indication of canceled codes.

The server processor accessing the instructions on the server storage may be configured to receive a request from the retailer computer system for a bulk code download, determine whether the request exceeds an allocated number of codes, and responsive to the request exceeding the allocated number of codes, not download any codes in response to the request to the retailer computer system. The server processor accessing the instructions on the server storage may be configured to determine whether at least one “critical date” pertaining to the request is satisfied and, responsive to determining that the critical date pertaining to the request is not satisfied, not satisfy the request. Furthermore, the server processor accessing the instructions on the server storage may be configured to download plural codes to satisfy the request responsive to the request not exceeding the allocated number of codes and responsive to determining that the critical date pertaining to the request is satisfied.

The supplier processor accessing the instructions on the supplier storage may be configured to present, on at least one display of the supplier computer system, at least one user interface (UI). The UI may include an indication of at least one top-selling product, an indication of product sales by at least first and second retailers, an indication of at least one request from at least one retailer computer system, and at least one product tab region operable to search for product sales information using one or more of plural filters.

In another aspect, a method includes receiving code information from a supplier computer at a digital code server (DCS). The code information includes information associated with retailer identity and product type. The method also includes receiving, at the DCS and from a retailer computer, a request for at least a first portion of the code information and determining, at the DCS, whether to provide the first portion to the retailer computer. Still further, the method includes, responsive to determining to provide the first portion, providing the first portion to the retailer computer.

In yet another aspect, at least one device includes at least one processor and storage accessible to the at least one processor. The storage bears instructions executable by the at least one processor to receive product code information from a supplier, with the product code information including at least one product code and information associated with a retailer authorized to sell the at least one product code. The instructions are also executable by the at least one processor to store the product code information and allocate the at least one product code to the retailer.

The details of the present application, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system including an example in accordance with present principles;

FIGS. 2 and 3 are schematic diagrams in accordance with present principles;

FIGS. 4-7, 9, 10, 13, 14, 16, 18, and 19 are example user interfaces in accordance with present principles; and

FIGS. 8, 11, 12, 15, and 17 are flow charts of example logic in accordance with present principles.

### DETAILED DESCRIPTION

This disclosure relates generally to computer ecosystems including aspects of consumer electronics (CE) device networks such as but not limited to computer game networks. A system herein may include server and client components, connected over a network such that data may be exchanged between the client and server components. The client components may include one or more computing devices including game consoles such as Sony PlayStation® or a game console made by Microsoft or Nintendo or other manufacturer virtual reality (VR) headsets, augmented reality (AR) headsets, portable televisions (e.g. smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple Computer or Google. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may include one or more processors executing instructions that configure the servers to receive and transmit data over a network such as the Internet. Or, a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system.

A processor may be any conventional general purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof; hence, illustrative components, blocks, modules, circuits, and steps are set forth in terms of their functionality.

The functions and methods described below, when implemented in software, can be written in an appropriate language such as but not limited to Java, C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optics and coaxial wires and digital subscriber line (DSL) and twisted pair wires. Such connections may include wireless communication connections including infrared and radio.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

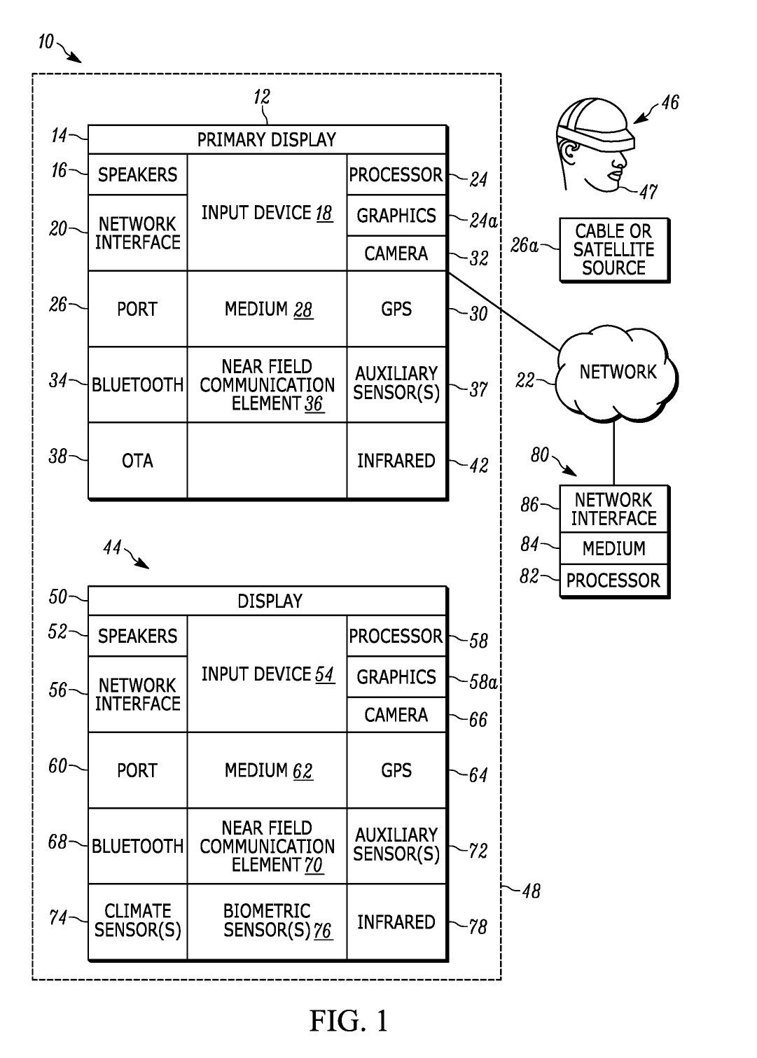

Now specifically referring to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to an Internet-enabled TV with a TV tuner (equivalently, set top box controlling a TV). However, the AVD 12 alternatively may be an appliance or household item, e.g. computerized Internet enabled refrigerator, washer, or dryer. The AVD 12 alternatively may also be a computerized Internet enabled (“smart”) telephone, a tablet computer, a notebook computer, a wearable computerized device such as e.g. computerized Internet-enabled watch, a computerized Internet-enabled bracelet, other computerized Internet-enabled devices, a computerized Internet-enabled music player, computerized Internet-enabled head phones, a computerized Internet-enabled implantable device such as an implantable skin device, etc. Regardless, it is to be understood that the AVD 12 is configured to undertake present principles (e.g. communicate with other CE devices to undertake present principles, execute the logic described herein, and perform any other functions and/or operations described herein).

Accordingly, to undertake such principles the AVD 12 can be established by some or all of the components shown in FIG. 1. For example, the AVD 12 can include one or more displays 14 that may be implemented by a high definition or ultra-high definition “4K” or higher flat screen and that may be touch-enabled for receiving user input signals via touches on the display. The AVD 12 may include one or more speakers 16 for outputting audio in accordance with present principles, and at least one additional input device 18 such as e.g. an audio receiver/microphone for e.g. entering audible commands to the AVD 12 to control the AVD 12. The example AVD 12 may also include one or more network interfaces 20 for communication over at least one network 22 such as the Internet, an WAN, an LAN, etc. under control of one or more processors 24. A graphics processor 24A may also be included. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the AVD 12 may also include one or more input ports 26 such as, e.g., a high definition multimedia interface (HDMI) port or a USB port to physically connect (e.g. using a wired connection) to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be, e.g., a separate or integrated set top box, or a satellite receiver. Or, the source 26a may be a game console or disk player containing content such as computer game software and databases. The source 26a when implemented as a game console may include some or all of the components described below in relation to the CE device 44.

The AVD 12 may further include one or more computer memories 28 such as disk-based or solid state storage that are not transitory signals, in some cases embodied in the chassis of the AVD as standalone devices or as a personal video recording device (PVR) or video disk player either internal or external to the chassis of the AVD for playing back AV programs or as removable memory media. Also in some embodiments, the AVD 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the AVD 12 is disposed in conjunction with the processor 24. However, it is to be understood that another suitable position receiver other than a cellphone receiver, GPS receiver and/or altimeter may be used in accordance with present principles to e.g. determine the location of the AVD 12 in e.g. all three dimensions.

Continuing the description of the AVD 12, in some embodiments the AVD 12 may include one or more cameras 32 that may be, e.g., a thermal imaging camera, a digital camera such as a webcam, and/or a camera integrated into the AVD 12 and controllable by the processor 24 to gather pictures/images and/or video in accordance with present principles. Also included on the AVD 12 may be a Bluetooth transceiver 34 and other Near Field Communication (NFC) element 36 for communication with other devices using Bluetooth and/or NFC technology, respectively. An example NFC element can be a radio frequency identification (RFID) element. Zigbee also may be used.

Further still, the AVD 12 may include one or more auxiliary sensors 37 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the processor 24. The AVD 12 may include an over-the-air TV broadcast port 38 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12.

Still referring to FIG. 1, in addition to the AVD 12, the system 10 may include one or more other CE device types. In one example, a first CE device 44 may be used to send computer game audio and video to the AVD 12 via commands sent directly to the AVD 12 and/or through the below-described server while a second CE device 46 may include similar components as the first CE device 44. In the example shown, the second CE device 46 may be configured as a VR headset worn by a player 47 as shown, or a hand-held game controller manipulated by the player 47. In the example shown, only two CE devices 44, 46 are shown, it being understood that fewer or greater devices may be used.

In the example shown, to illustrate present principles all three devices 12, 44, 46 are assumed to be members of an entertainment network in, e.g., a home, or at least to be present in proximity to each other in a location such as a house. However, present principles are not limited to a particular location, illustrated by dashed lines 48, unless explicitly claimed otherwise.

The example non-limiting first CE device 44 may be established by any one of the above-mentioned devices, for example, a portable wireless laptop computer or notebook computer or game controller (also referred to as “console”), and accordingly may have one or more of the components described below. The first CE device 44 may be a remote control (RC) for, e.g., issuing AV play and pause commands to the AVD 12, or it may be a more sophisticated device such as a tablet computer, a game controller communicating via wired or wireless link with the AVD 12, a personal computer, a wireless telephone, etc.

Accordingly, the first CE device 44 may include one or more displays 50 that may be touch-enabled for receiving user input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. A graphics processor 58A may also be included. Thus, the interface 56 may be, without limitation, a Wi-Fi transceiver, which is an example of a wireless computer network interface, including mesh network interfaces. It is to be understood that the processor 58 controls the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or Wi-Fi transceiver as mentioned above, etc.

In addition to the foregoing, the first CE device 44 may also include one or more input ports 60 such as, e.g., a HDMI port or a USB port to physically connect (e.g. using a wired connection) to another CE device and/or a headphone port to connect headphones to the first CE device 44 for presentation of audio from the first CE device 44 to a user through the headphones. The first CE device 44 may further include one or more tangible computer readable storage medium 62 such as disk-based or solid state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower, using triangulation, and provide the information to the CE device processor 58 and/or determine an altitude at which the first CE device 44 is disposed in conjunction with the CE device processor 58. However, it is to be understood that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor (e.g. for sensing gesture command), etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44. The CE device 44 may communicate with the AVD 12 through any of the above-described communication modes and related components.

The second CE device 46 may include some or all of the components shown for the CE device 44. Either one or both CE devices may be powered by one or more batteries.

Now in reference to the afore-mentioned at least one server 80, it includes at least one server processor 82, at least one tangible computer readable storage medium 84 such as disk-based or solid state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server or an entire server “farm”, and may include and perform “cloud” functions such that the devices of the system 10 may access a “cloud” environment via the server 80 in example embodiments for, e.g., network gaming applications. Or, the server 80 may be implemented by one or more game consoles or other computers in the same room as the other devices shown in FIG. 1 or nearby.

Further to what has been alluded to above, logical blocks, modules, and circuits described below can be implemented or performed with a general purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a hard disk drive, CD ROM or Flash drive. The software code instructions may also be downloaded over the Internet.

Before moving on in the detailed description, it is to be understood that voucher/digital codes will be disclosed herein. These voucher codes, which may be pins, may be created by a supplier of a product so that an end-user may ultimately purchase the voucher code and redeem it to access the associated product. More than one voucher code may be associated with the same product. Examples of products for which voucher codes may be used include video games, add-ons for the video games, other software, funds for use in an online marketplace, etc.

For instance, the product may be a video game produced by the supplier. A user wishing to purchase or access the video game may go to a retail store or online marketplace and then purchase one of many voucher codes from the retailer that are each useable to access the same video game. The voucher code that is purchased may be indicated on the user's purchase receipt or on a separate tangible card or document provided at the point of sale. Additionally or alternatively, the voucher code may be indicated in an email to the user that is transmitted from the supplier to the user responsive to purchase of the voucher code. The user may then access their video game system, login to their video gaming account (e.g., hosted by the supplier) using the video game system, and enter the voucher code at an appropriate user interface for doing so. Once the voucher code is entered, the code may be securely transmitted to the supplier's computer system to verify that the voucher code is legitimate, has in fact been purchased through an appropriate distribution channel, and has not already been redeemed/used using a different user account. Responsive to this verification, the supplier may make the video game available for download through the user's account so that the video game may be stored and played on the user's video game system.

Thus, it is to be further understood that there may be a consumption limit for each voucher code provided by the supplier, which may be set to “1” in that the voucher code may only be redeemed once and associated with a single user account. For example, there may be one million codes in the same voucher code batch, each with a redemption of “1” which entitles one user account to access a video game for repeated gameplay as many times as the user may choose. The user may use their account to log in to their own computer/video game system to access the video game as many times as they wish, and may also use their account to login to other computers/video game systems to access the product such that once redeemed the voucher code may always be associated with the same account through which it was redeemed and no other accounts. However, if another user account was used to try to redeem the same voucher code (regardless of which computer/video game system was being used), the system may deny them access owing to the consumption limit being set to “1” and the code already having been redeemed using a different user account. This may help to prevent fraudulent access to the product.

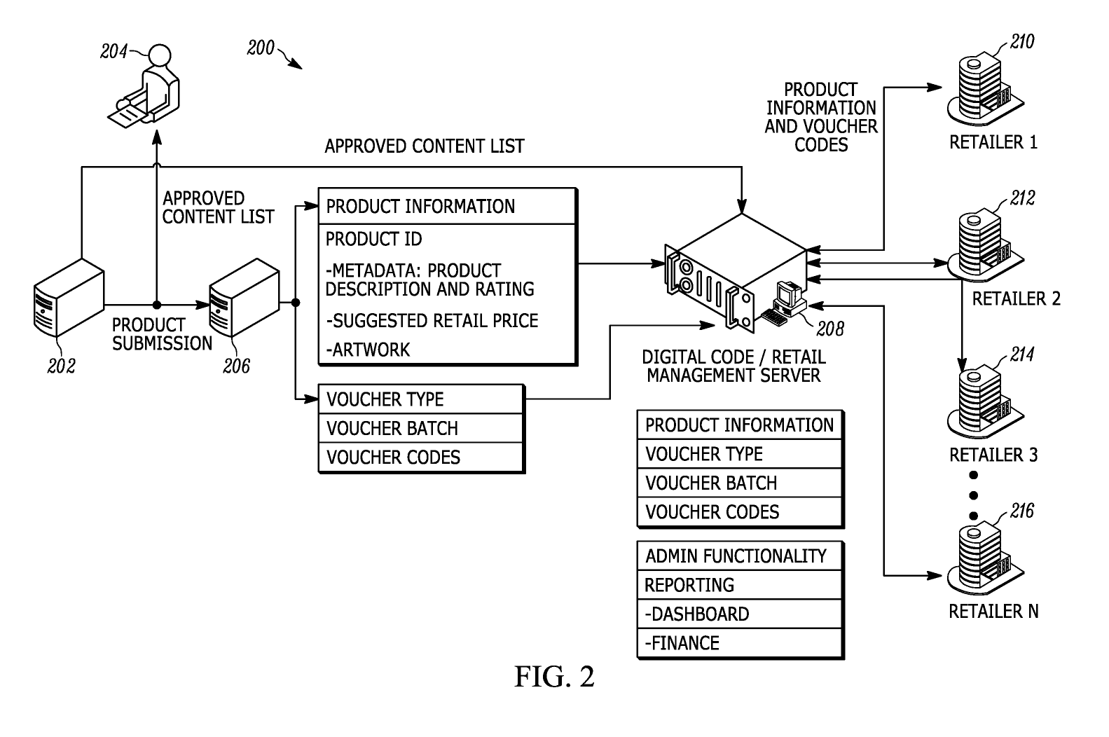

Now describing FIG. 2, it shows an example system 200 in accordance with present principles, where each computer system described in reference to FIG. 2 may include some or all of the components described above in reference to the devices of FIG. 1 described above. The system 200 may include a third party relations network computer system 202 operated by a supplier or manufacturer (referred to as a “supplier” below for simplicity) such as Sony PlayStation® via one or more digital supply managers 204. The computer system 202 may be used by publishing partners of the supplier and also supply/retail partners of the supplier to submit products to the supplier.

Data such as an approved content list may be uploaded by the manager 204 from a supplier's computer system, and/or the computer system 202, to a digital code server (DCS) 208 that is accessible over a network such as the Internet. The approved content list may indicate and include content and products from third parties that are then to be supplied to approved retailers 210-216 by the supplier for sale by the retailers 210-216. The approved content list may also indicate and include content and products from the supplier itself.

Also shown on the supplier side of the system 200 is a product management tool computer system 206 at which the supplier manages content and products (e.g., video games, funds for a marketplace wallet, etc.) to be sold by the supplier, for example, through the supplier's own online marketplace. Additionally, the computer system 206 may be used to create and store voucher/digital codes that are redeemable in order to access the products themselves in accordance with present principles. Voucher/digital codes may then be downloaded from computer system 206 to another computer system (not shown) that is operated by the supplier manager 204. The codes may be downloaded in one or more of comma-separated value (csv) format and text file (txt) format (though excel (XSL) format and extensible markup language (XML) format may also be used), with the codes being automatically generated by the computer system 206 itself per a supplier-approved code-generating algorithm. Additionally or alternatively, the codes may be manually created at the computer system 206 under direction of the supplier manager 204. In either case, each code that is generated is understood to be unique such that no two codes are the same.

The supplier may then transfer/upload the csv or txt file housing the codes (and/or transfer the content of the file itself) to the DCS 208 via a supplier computer system such as the computer system 206. Additionally or alternatively, the supplier/supplier computer system may transfer the content of the csv or txt file into a spreadsheet file such as an xsl or xlsx file which may then be uploaded to the DCS 208. The codes indicated in the file and/or the file itself that is uploaded to the DCS 208 may be encrypted using Pretty Good Privacy (PGP) encryption and stored in encrypted format on the DCS 208. Each line of the file that is uploaded to the DCS 208 may include one or more of the voucher code itself, a voucher control number, a voucher type, a batch and/or batch ID, and an SKU (stock keeping unit) for the product associated with the voucher code.

Describing voucher types in more detail, they may be created in order for voucher batches to be created. Voucher types may act as containers for SKUs. For example, if the supplier wanted to create voucher codes for a particular video game, the supplier may create a voucher type for the game and attach/associate the SKU for the video game to the voucher type. Thus, the hierarchy may be as follows: voucher types, then voucher batches within the voucher types (e.g., with different batches for different retailers), and then voucher codes within the voucher batches.

Still in reference to FIG. 2, the supplier may also upload an additional, separate spreadsheet file to the DCS 208 via another computer system such as the computer system 206. The separate spreadsheet file may be an xml, xsl, or xlsx file, and will be referred to herein as a content information list. The content information list may include metadata about products and the one or more voucher codes associated with those products that are generated at the computer system 206. The metadata may include, for example, format, product type, voucher type, voucher batch ID, product name, product SKU, publisher, release date (e.g., in Pacific Standard Time), preorder date (e.g., in Pacific Standard Time), suggested retail price, genre, content rating (e.g., Entertainment Software Rating Board rating), a long description of the product, a legal disclaimer and terms and conditions, assigned retailers for the product (e.g., retailers 210-216), and artwork assets associated with the product. Additionally, retailer margins may also be included as metadata, with the margins being defined by maximum amounts (or percentages) above and below the supplier's suggested retail price at which the retailer has been authorized by the supplier to sell the product/voucher codes.

New and/or updated content information lists may then be uploaded to the DCS 208 to update the DCS 208 on any and all changes to products and product metadata that the supplier may subsequently make, such as particular products assigned/unassigned to a given retailer for sale by the retailer, preorder date changes for one or more products, description and price changes for one or more products, release date changes for one or more products, etc. Once these changes are uploaded to the DCS 208, a retailer's product detail page hosted by the DCS 208 and accessible by a computer system of the retailer may be updated with the most-current product information.

The supplier may thus upload a new version of the content information list to the DCS 208 so that all changes related to a given product may be made (e.g., made to each retailers' product detail page) within a time frame that may be specified by the supplier. Accordingly, the content information list may also contain at least one date and/or time specifying when all or particular changes are to take effect and hence when a retailer is to begin selling certain codes according to the changes. Furthermore, in some embodiments, by uploading a given content information list the supplier may bulk-upload product assets and metadata to the DCS 208 for plural products (rather than uploading on a product-by-product basis).

Then, responsive to the changes being uploaded to the DCS 208 via the content information list (and/or responsive to the date and time being reached for when the changes are to take effect), the DCS 208 may identify the changes based on a comparison to previously uploaded data and generate an alert message (such as an email) that is transmitted to one or more retailers that have been allocated or assigned a product to which a given change pertains. The alert message may direct the retailer to confirm or acknowledge a product change to the DCS 208 and hence supplier. If the alert message is provided by the DCS 208 in an email to the retailer, the confirmation or acknowledgement may be made in a reply email back to the DCS 208 (e.g., responding “acknowledged” or “accepted”), and/or may be made by selecting a link or button contained in the email that initiates a transmission to the DCS 208 indicating the retailer's acknowledgement or acceptance.

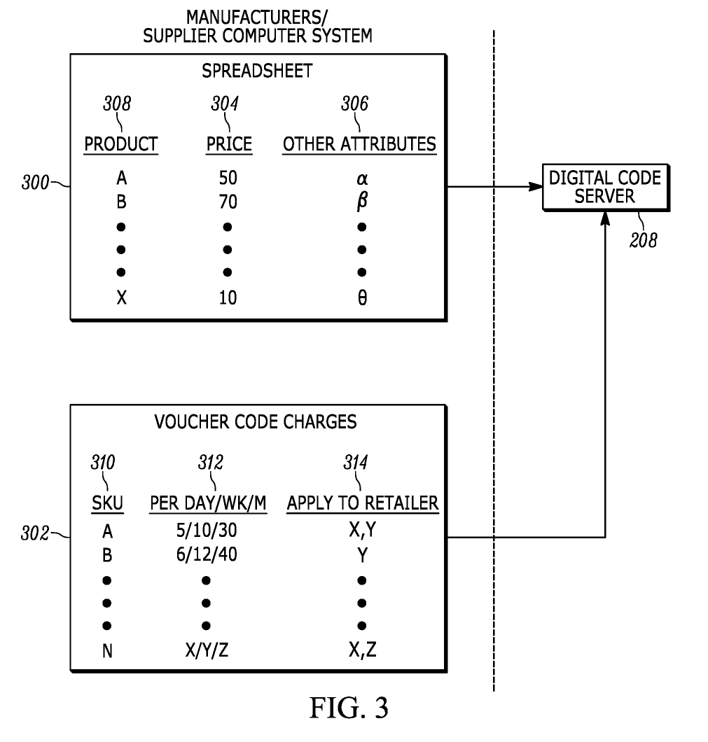

FIG. 3 shows examples of content information lists 300, 302 that may be uploaded to the DCS 208. As may be appreciated from FIG. 3, the content information list 300 may be editable to specify price updates 304 and other product attribute updates 306 for respective products 308 that are to replace previous data sets. All the updates indicated on the list 300 may be new, or some of the data in the list 300 may be the same as before or left blank if the same.

Additionally, content information list 302 may be editable to specify changes related specifically to voucher codes for various respective products 310 identified by SKU as shown. The list may specify a maximum number of voucher codes 312 the supplier/manufacturer has authorized one or more retailers 314 to sell for a given time period specified in the list 302, such as per day, per week, and per month as shown on the list 302. As an example, the list 302 may provide an update that a product having an SKU of “A” may be sold (via selling its associated voucher codes) by retailers “X” and “Y” at a frequency of five maximum per day, ten maximum per week, and thirty maximum per month. All the updates indicated on the list 302 may be new, or some of the data in the list 302 may be the same as before or left blank if the same.

Once the lists 300, 302 have been uploaded to the DCS 208, the DCS 208 may propagate/apply the changes immediately or at a time specified in the list 300, 302 for all updates or on per-product basis (e.g., in another column for each product but not shown for simplicity). Alerts may also be generated and transmitted to all authorized retailers or only to retailers to which the given changes apply responsive to the lists 300, 302 being uploaded. Additionally or alternatively, the alerts may be generated and transmitted when the changes are actually to take effect or at a threshold time prior to when the changes are to take effect.

Referring back to FIG. 2 and further describing metadata that may be indicated in and updated via a content information list, in some examples the metadata may vary based on a country in which each of the retailers 210-216 sells products. Metadata/assets that may vary based on country may include product artwork and product description. Terms and conditions as well as other legal statements and disclaimers may also vary such that they may be provided in a given language (e.g., English, Spanish, French, or Portuguese) based on that language being spoken by the majority of people in a given country in which the product/voucher code is to be sold. Notwithstanding the foregoing, it is to be understood that each of these assets that may vary based on country may still be associated with the same product SKU for the same product (that may be universal) so that when a voucher code for the product is assigned to a given retailer for sale in a given country, all the assets by country may be available to that retailer and ultimately to the customer via the voucher code that is sold (along with the product itself).

Further describing the DCS 208, it is to be understood that it may also include certain administrative functionalities so that the manager 204 can view and/or download reports related to voucher codes that have been sold and that have been left unsold by the approved retailers 210-216 to which respective voucher codes or code sets have been assigned (as provided by the DCS 208). Sold codes may have been sold at physical “brick and mortar” stores and/or through each retailer's own e-commerce/online marketplace.

For example, the manager 204 may log in to the DCS 208 to view such reports using a web-based portal for accessing the reports at the DCS 208. The manager 204 may also download such reports from the DCS 208 in xlsx format after the report is generated in that format by the DCS 208. These reports may be searched and sorted by product and/or by product attribute (e.g., name, type, release date, preorder date, genre, status, etc.). Reports may also be searched and sorted by retailer to which a given product is currently assigned or allocated.

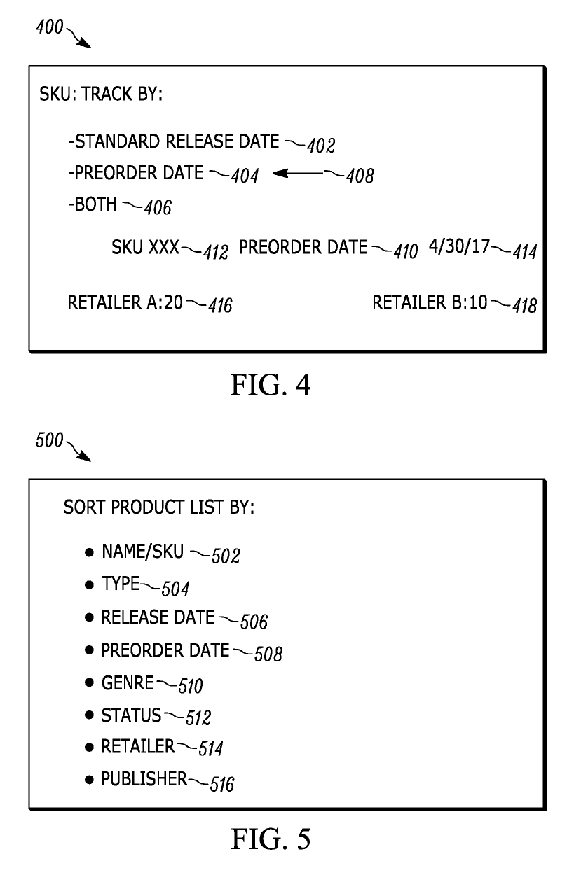

Continuing the detailed description in reference to FIG. 4, it shows an example user interface (UI) 400 presentable on a display of a supplier's computer system in accordance with present principles. But before getting into detail regarding the UI 400, it is to be understood that a system/DCS in accordance with present principles may have the ability to track a given product's standard release date, which may be the date that product and its voucher codes are made available and active to the public/consumer through retail channels so that the user may be able to download/access the full file of the product by redeeming one of the voucher codes. The system may also have the ability to track a product's preorder date, which may be the date the supplier authorizes a product and its voucher codes to be active so that they may be sold by retailers even if the customer is not able to redeem one of the voucher codes to fully access the product until the standard release date. The preorder date may last from its beginning up until the standard release date.

The tracking itself may be performed by periodically checking data stored at and/or accessible to the supplier's computer system that indicates the dates and related information. Additionally or alternatively, the tracking may be performed based on periodic communication with and/or login to the DCS to identify the dates and related information as stored at the digital code server.

Accordingly, so that the supplier can track product distribution to retailers by both dates (standard release and preorder dates), the UI 400 may include a selector 402 that is selectable for the supplier's computer system to access and present information related to a certain product's standard release date. The UI 400 may also include a selector 404 that is selectable for the supplier's computer system to access and present information related to the product's preorder date, as well as a selector 406 that is selectable for the supplier's computer system to access and present information related to both the product's standard release date and preorder date. As may be appreciated from FIG. 4, arrow 408 indicates that the preorder date selector 404 has been selected in this example, and accordingly information 410 may be presented responsive to selection of the selector 404. The information 410 may include the product's SKU 412 and preorder date 414.

Additionally, the UI 400 may include information 416 indicating a number of units (voucher codes) of the product that have been allocated to a first retailer for sale by the first retailer and information 418 indicating a number of units of the product that have been allocated to a second retailer for sale by the second retailer. Also note that the information 416 and 418 may be edited by selecting the area at which the information 416, 418 is respectively presented. Thus, responsive to selection of one of the areas, a number entry box may be presented at the area at which the supplier/supply manager may enter a different number to thereby allocate a different number of voucher codes to the respective retailer than were previously allocated.

FIG. 5 shows a UI 500 that may also be presented on the display of a supplier's computer. The UI 500 may be for, as alluded to above, viewing and downloading reports related to products and associated voucher codes. The UI 500 may be part of a sortable feature for a spreadsheet generated by a DCS (e.g., an .xlsx document) in accordance with present principles, and/or may be part of a software module that itself may access and sort data from the spreadsheet. Regardless, the UI 500 may include selectors 502-514 that are selectable for respectively sorting lists of products by name and/or SKU (502), product type (504), product release date (506), product preorder date (508), genre (510), status (512), retailer (514), and publisher (516) so that products may be listed on a subsequent UI or on the spreadsheet in ascending or descending order based on which selector is selected.

In addition to generating reports as described above, the DCS may also log all changes to products that are made, for example, by uploading a spreadsheet to the DCS that indicates the updates/changes to the product attributes. The log may track all attribute changes to a product, including the attribute value before and after the change as well as the date and time of the change (e.g., when the change is to take effect and/or when the change was uploaded). This information may also be listed on the sortable spreadsheet and/or UI.

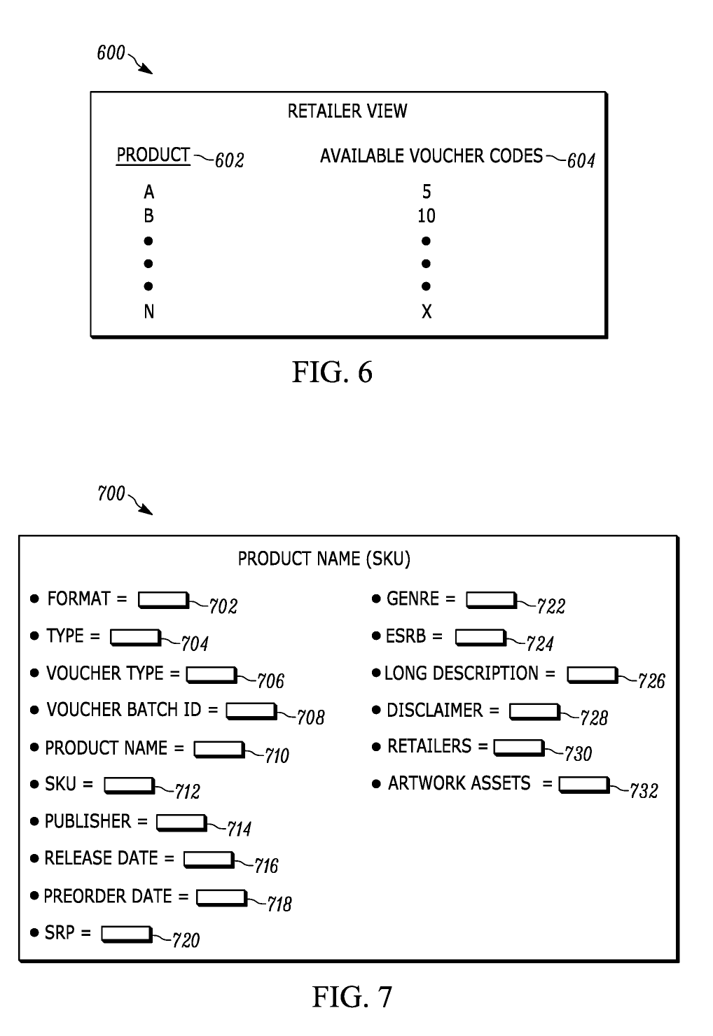

Moving on in the detailed description, reference is now made to FIG. 6. It shows a user interface 600 presentable on the display of a retailer's computer in accordance with present principles so that a given retailer may be able to view the quantity/quota of voucher codes assigned and still available (still unsold) to that retailer via a DCS, with the quantities being sorted and searchable by respective product and also updated (e.g., reduced) responsive to sales of voucher codes by the retailer. The UI 600 may be accessed based on retailer login to the DCS to access the information via a web portal hosted by the DCS. As may be appreciated from FIG. 6, the UI 600 may include a column 602 listing products and a column 604 listing voucher codes for each respective product that are allocated to that particular retailer for sale by the retailer.

As with the other figures, FIG. 6 is an example. Accordingly, it is to be understood that more-detailed UIs may also be presented so that retailers can use those UIs to search and sort by products assigned to them on other bases. For example, retailers may use such a UI to sort and set filters by product attribute (e.g., name, type, release date, preorder date, genre, status, etc.). Retailers may also be able to download this information via an .xlsx or other spreadsheet file to search and sort the spreadsheet file in a similar manner.

FIG. 7 shows a product information editor UI 700 that may be presented on the display of a supplier's computer system in accordance with present principles. The UI 700 may be for establishing and editing information in a content information list for a given product. Once information is established or edited via the UI 700 for a given product, the supplier's computer and/or DCS may populate or change fields of the content information list for a given product according to the changes made to the product via the UI 700. The UI 700 may include respective input fields 702-732 for format (702), product type (704), voucher type (706), voucher batch ID (708), product name (710), product SKU (712), publisher (714), release date (716), preorder date (718), suggested retail price (720), genre (722), content rating (724), a long description of the product (726), a legal disclaimer and terms and conditions (728), assigned retailers for the product (730), and artwork assets associated with the product (732).

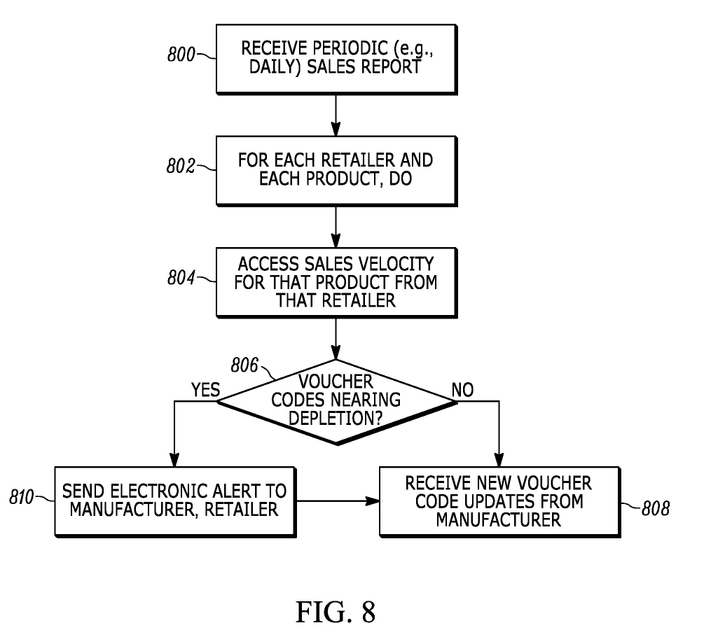

Continuing the detailed description in reference to FIG. 8, it shows example logic that may be executed by a digital code server in accordance with present principles. The logic may be executed so that, based on a supplier's defined sales velocity for a given product's voucher codes in total and for particular retailers, an email alert may be sent to the supplier when the product's voucher codes are about to be depleted. For example, if three hundred voucher codes for a certain product were distributed on-demand by the DCS to a particular retailer in the previous two days, and based on that velocity the DCS will be depleted of the allocated amount of voucher codes (e.g., the quota for that retailer or for all retailers) by the end of the week, an alert message may be generated and sent to the supplier/supplier manager so that they can allocate more voucher codes if desired.

Accordingly, the logic of FIG. 8 may begin at block 800 where the logic may receive and/or generate one or more periodic sales reports, such as once every hour or once every day. The report(s) may indicate the number of voucher codes sold by all retailers and also may indicate the number of voucher codes sold by each particular retailer. The sales reports may also indicate, based on the number of voucher codes sold and the bottom-end of the retailer margin for a given retailer, the minimum amount of money the supplier has received and/or should expect to receive from the retailer based on the number of voucher codes that retailer has sold. The logic may then move to block 802 where the logic may perform steps 804-810 for each retailer and/or each product. Also at block 802, in some embodiments these sales reports may be provided (e.g., via email) in .xlsx format or otherwise be made available based on login to the DCS so that supplier users may view the reports.

From block 802 the logic may then move to block 804. At block 804 the logic may access or determine, from the sales report(s) that are generated, sales velocity for a given product's voucher codes as sold by a given retailer. The logic may then proceed to decision diamond 806 where the logic may determine whether voucher codes are nearing depletion for the product and/or retailer of that product. Whether depletion is nearing may be defined, for example, based on whether a threshold number or threshold percentage of voucher codes remaining has been reached, or based on whether a threshold number or percentage of voucher codes sold has been reached. Thresholds and corresponding alert messages may be established for each retailer and/or for each product.

Responsive to a negative determination at diamond 806, the logic may proceed to block 808 where the logic may receive any new voucher code updates from the supplier/manufacturer based on any changes the supplier/manufacturer may wish to make. However, responsive to an affirmative determination at diamond 806, the logic may first proceed from diamond 806 to block 810 before subsequently proceeding to block 808. At block 810 the logic may send electronic alerts to both the supplier/manufacturer and the retailer indicating that voucher codes for a given product as assigned to that particular retailer are nearing depletion. For example, the alert may be an email and may specify the number of voucher codes sold and remaining for a particular time frame.

Moving on from FIG. 8, it is to be understood in accordance with present principles that retailers may have reports generated by the DCS (e.g., in spreadsheet format) for their viewing as well. Retailer reports may provide retailers with indications of all changes to the products that they have been assigned by the supplier over a given period of time. Moreover, retailers may be allowed to manage the distribution of alerts and reports to its retailer users, such as the timing of when such alerts and reports are provided, the format in which they are provided, etc. Similarly, a supplier may be allowed to manage the distribution of alerts and reports to its supplier users.

It is to also be understood in accordance with present principles that a supplier may use a DCS in accordance with present principles to run a digital inventory report on demand and also schedule such reports to be run and sent to the supplier via email. The reports may indicate voucher code inventory by product and may include sortable filters based on voucher creation date and voucher batch ID. The report may be made available in .xlsx format.

Additionally, the supplier may also use the DCS to run content distribution reports on demand and also schedule such reports to be run and sent to the supplier via email. The report may show all voucher codes that have been sold/distributed to retailers. It may include sortable filters based on date range, voucher code status (e.g., sold or unsold), retailer, content/product name, and age of voucher code. In some embodiments, the report may be made available in.xlsx format.

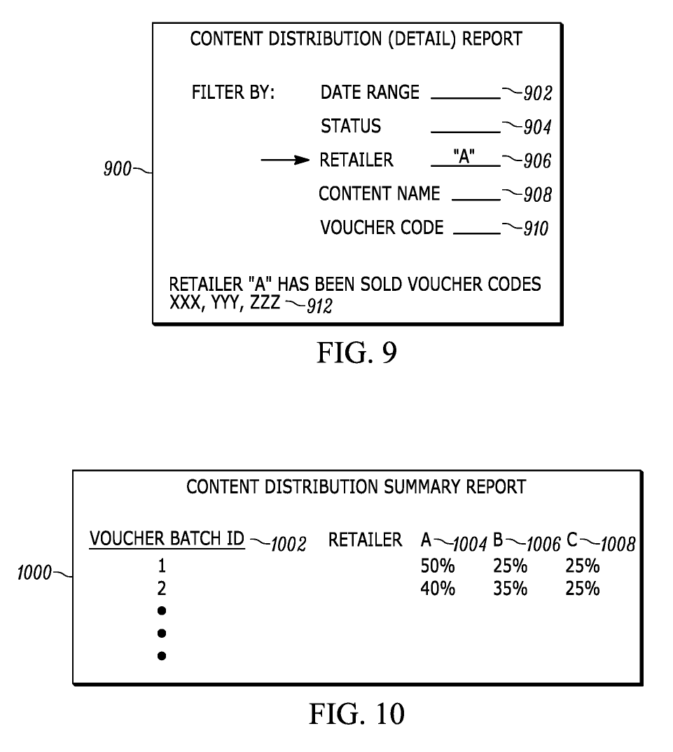

An example of a content distribution report is shown in FIG. 9. A report 900 is shown and may have filters/input fields for date range (902), status (904), retailer (906), content name (908), and voucher code (910). In the example shown, filter 906 has been used to specify a report be generated for retailer “A”, and accordingly report information 912 may also be presented on the report 900 that lists voucher codes sold to or by retailer “A”.

A supplier may also be able to run a content distribution summary report on demand and also schedule such reports to be run and sent via email. The report may show all distribution percentages across different retailers according to voucher batch ID. The report may be made available in .xlsx format.

An example of a content distribution summary report is shown in FIG. 10. An example report 1000 is shown. The report 1000 includes a first column 1002 listing voucher batch IDs, a second column 1004 for distributions of each batch ID to retailer “A”, a third column 1006 for distributions of each batch ID to retailer “B”, and a fourth column 1008 for distributions of each batch ID to retailer “C”.

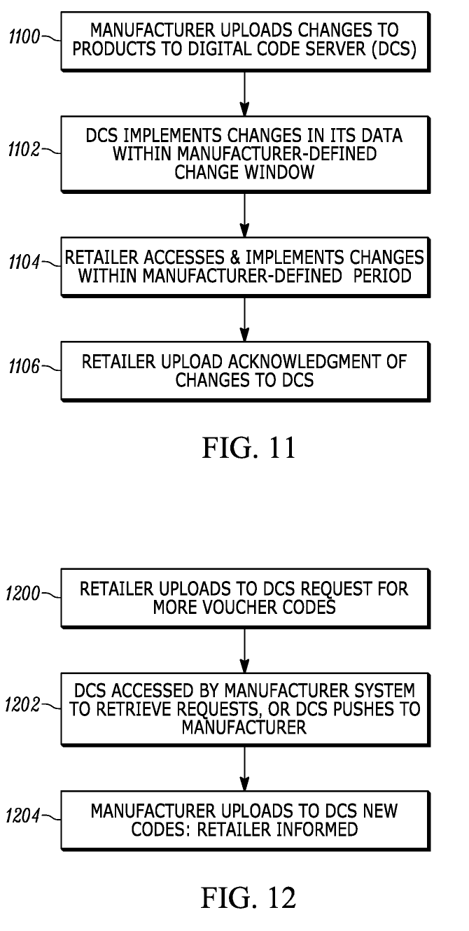

Now describing FIG. 11, it shows example logic that may be executed by an example system in accordance with present principles, such as a digital code server (DCS). The logic may be executed so that a supplier/manufacturer may make changes to products and corresponding voucher codes at the DCS. The logic may begin at block 1100 where the supplier may upload to the DCS, as a spreadsheet, changes to products via the supplier's computer system. Then at block 1102 the DCS may implement the changes in its data within a supplier-defined time window in which the changes have been scheduled to take effect. The logic may then move to block 1104 where a retailer may access or otherwise be notified of the changes and implement the changes within the supplier-defined window. From block 1104 the logic may proceed to block 1106 where the retailer may upload or otherwise transmit to the DCS acknowledgement of the changes, which may then be routed to the supplier if desired.

Changes may be to a product attribute (e.g., price, description), a new product being allocated to the retailer, and/or a change to the product assets (e.g., artwork, terms and conditions). The DCS may notify the retailer via email or web-based portal of all product attributes, etc. that have changed, and may even indicate what the attribute was before a well as after the change. Changes by the supplier may also be to upload and/or remove individual product assets for a given product. Changes to a product asset or attribute may be reflected in the asset information as available to all retailers assigned the product for which the change in asset has been made.

The DCS may also be used for allowing a retailer to request that a pool of unsold voucher codes for a particular product be increased/refilled and hence to make more codes available to that retailer. For example, if a retailer knows that it will be starting a sale/promotion for a particular product and anticipates selling a larger-than-usual number of voucher codes for that product over the next month, they may request additional voucher codes from the supplier/manufacturer. As another example, should a retailer sell all voucher codes allocated to it for a given time period, the retailer may request more voucher codes from the supplier/manufacturer.

To make such a request, the logic of FIG. 12 may be implemented by the DCS. At block 1200 the retailer may upload, to the DCS, a request for more voucher codes for a given product such as if, for example, the retailer has reached their previous voucher code quota. The logic may then proceed to block 1202 where the logic may permit access to the DCS by the supplier to retrieve requests for additional voucher codes. Additionally or alternatively, at block 1202 the DCS may push the requests to the supplier/manufacturer, e.g., responsive to the request from the retailer being received at the DCS or at a predefined time on a recurring basis.

From block 1202 the logic may move to block 1204. At block 1204 the supplier may upload to the DCS new codes for the retailer to sell, assuming the supplier wishes to allocate additional codes to that retailer. Also at block 1204, the retailer may be informed that additional codes have been allocated, such as via an email sent to the retailer and/or via an online portal to the DCS to which the retailer may login.

In addition to the foregoing, a DCS in accordance with present principles may be used by retailers to request that a new retailer user be granted access to the DCS. This is because while in some embodiments retailers may be enabled to remove their current users from the DCS system without having to submit a request to the supplier, the supplier may still wish to authorize new retailer users itself that a given retailer would like to have access to the system so that the new retailer user may, e.g., request more voucher codes. Should the retailer request access for a new retailer user, the retailer may specify if it is requesting user access for an order role or an order approval role. In some embodiments, retailers may maintain at least one user in the order approval role to approve an order to be sent to the DCS and/or supplier after such an order is made by a retailer user with an order-only role. One or more user interfaces (UI)s may be presented on a retailer's computer system for such tasks.

For retailer users, order role users may use the DCS to bulk-order products and voucher codes, to run product reports, to download product assets, and to request addition of new retailer users and/or changes to the accounts of existing retailer users. For order approval role users on the retailer's end of the system, the approval role user may use the DCS to approve bulk orders of products and voucher codes, approve new order role users for the retailer, change and/or edit the retailer's company information stored at the DCS, and manage distribution of alerts and reports to the retailer's order role users. One or more user interfaces (UI)s may be presented on a retailer's computer system for such tasks.

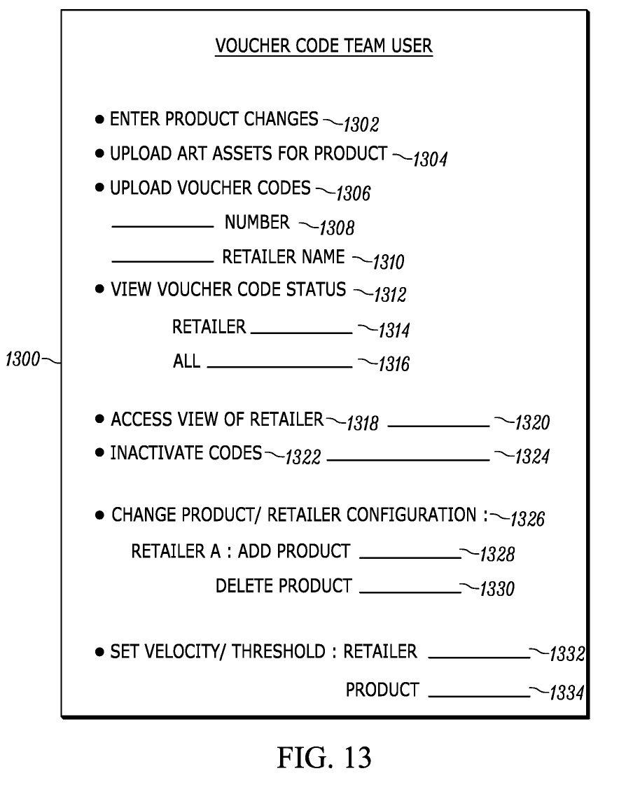

Moving on to supplier-side users, it is to be understood that once uploaded to the DCS by the supplier, voucher codes may in some examples only be accessible to supplier users that belong to the supplier's voucher code team. FIG. 13 shows a user interface 1300 that may be presented on a display of a supplier computer system for a voucher code team member to perform actions related to voucher codes. Each selector shown on the UI 1300 may be selectable to perform a given action associated with the selector. For example, selector 1302 may be selected for a voucher code team member to make product changes (e.g., one-off changes to a product attribute or asset). Selector 1304 may be selected to upload product assets (e.g., one-off uploads).

Option 1306 may also be presented on the UI 1300, with a voucher entry field 1308 being presented at which a voucher code team member may enter voucher codes to be uploaded and with a retailer name field 1310 being presented at which a voucher code team member may enter a retailer to which the voucher codes entered to field 1308 are to be allocated.

Additionally, the UI 1300 may include a view voucher code status option 1312 so that a voucher code team member can view inventory/distribution reports for a given retailer specified at input field 1314 or for all retailers based on input to field 1316. The UI 1300 may even include an option 1318 to access a retailer's view of the system (e.g., the retailer's view of the retailer's web portal to the DCS) based on input to the input field 1320 specifying a particular retailer for which to show that retailer's associated view. Though not shown for clarity, the UI 1300 may also include an option at which new users and role access may be approved for both the supplier and retailers that have pending role requests with the DCS.

Still further, the UI 1300 may include an option 1322 at which certain voucher codes may be deactivated or voided. The voucher code(s) to be deactivated or voided may be entered to input field 1324.

As may also be appreciated from FIG. 13, the UI 1300 may include an option 1326 to change existing product/retailer configurations. For example, input field 1328 may be used to add/assign a product (and hence voucher codes) for sale to a given retailer, and input field 1330 may be used to remove/unauthorize a product (and hence voucher codes) for sale by a given retailer.

Additionally, a sales velocity threshold in accordance with present principles may also be defined via the UI 1300 for a given product, such as the product for which input has been directed to field 1328. Input field 1332 may be used to set a threshold (e.g., maximum sales velocity) for a particular retailer. Input field 1334 may be used to set a threshold for a particular product, such as a product sold by all retailers in total or as sold by an individual retailer to which the product has been assigned.

In addition to voucher team members, a supplier may also have security team members. The security team members may, in some embodiments, have read-only access to most features of the DCS, except for the actual voucher codes and the velocity limits of retailers to which security team members may not have any access or to which they may have full access. Finance users of the supplier may also have read-only access to all views and reports, with finance users being able to pull reports of sold inventory/voucher codes using voucher control numbers such as voucher batch IDs.

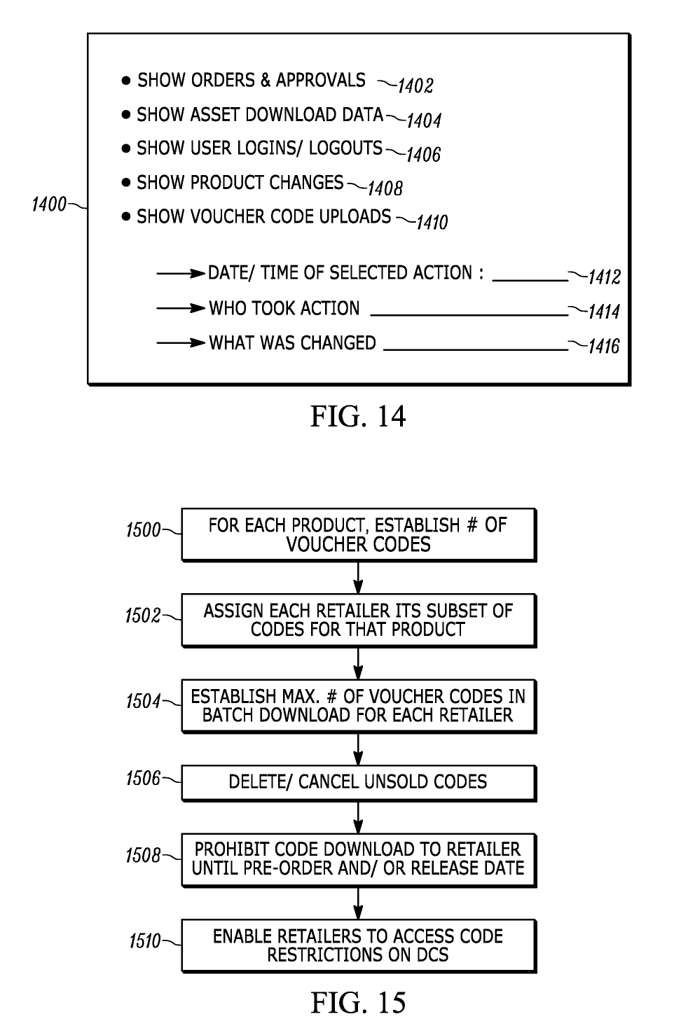

Reference is now made to FIG. 14. FIG. 14 shows an example user interface 1400 for a DCS to present information/logs related to its tracking of actions and/or users. The UI 1400 may be presented, for example, on the display of a supplier's computer system, or the display of a retailer's computer system with tracking results pertaining to the particular retailer that is accessing the DCS. The UI 1400 may include various selectors 1402-1410 that are respectively selectable to present information indicated in the text of the selectors 1402-1410 on a separate UI or a UI overlaid on the UI 1400.

As may be appreciated from FIG. 14, selector 1402 may be selected for the DCS to present information indicating orders and order approvals, selector 1404 may be selected for the DCS to present information indicating downloads of product assets such as artwork and product details, and selector 1406 may be selected for the DCS to present information indicating various user logins and logouts (e.g., supplier user logins/logouts or retailer user logins/logouts). Additionally, selector 1408 may be selected for the DCS to present information indicating product changes, such as one-off changes to products done by uploading a content information list as disclosed herein. Selector 1410 may be selected to present information indicating voucher code uploads to the DCS. The information or logs that are presented based on selection of each of the selectors 1402-1410 may indicate the date/time when each action took place, the user who took each action, and what changed during each action (such as a price change for a given product from $50 to $40).

Furthermore, in some embodiments the information that may be presented by selecting one of the selectors 1402-1410 may be tailored or filtered so that information is only presented for associated actions occurring on a specific date and time (or time range) by providing date/time input to input field 1412, for associated actions that a particular user(s) took by specifying a particular user(s) in input field 1414, and for specific changes or types of changes that were made by indicating the specific change(s) in input field 1416.

Moving on from FIG. 14, it is to be understood in accordance with present principles that an operator of the DCS, such as the supplier, may work with retailers to integrate the retailers' systems with the DCS using a universal protocol application program interface (API), even though retailer integration with the DCS may be adapted on an individual-retailer basis instead if needed to meet a particular retailer's preferences or needs (e.g., should that retailer have its own API protocols it wishes to use). But in any case, an API in accordance with present principles may include on-demand voucher code order integration, as well as bulk-order integration. However, to reiterate, in some examples the DCS may not permit voucher codes to be downloaded unless the associated product's pre-order date and/or actual release date has arrived. In any case, the API itself may be built and/or configured by the supplier itself or by a third party builder with whom the supplier has a confidential relationship for such purposes.

Continuing the detailed description in reference to FIG. 15, it shows a flow chart of example logic that may be executed to enable a supplier to manage its voucher codes by product and retailer. The flow chart of FIG. 15 may executed by a digital code server in accordance with present principles, though it is to also be understood that if desired certain parts of the flow chart may be executed in conjunction with the supplier's computer system itself. In any case, the logic may be executed responsive to and based on upload of data via a content information list as disclosed herein, and/or based on a supplier user providing a request to the DCS for a particular change to be made.

The logic of FIG. 15 begins at block 1500 where the logic may, for each product, establish a number/quantity of voucher codes available to each and/or all retailers. The logic may then move to block 1502 where the logic may assign to each retailer its allocated subset of voucher codes for the given product. The logic may then proceed to block 1504 where the logic may establish a maximum number of voucher codes that may be downloaded in a single bulk order by each retailer (e.g., as may be specified by the supplier).

From block 1504 the logic may then proceed to block 1506. At block 1506 the logic may delete and/or cancel voucher codes that have not been sold (such as those left unsold within a date/time range specified by the supplier). Deletion and/or cancellation may automatically change the status of the voucher code to “canceled”, even if the voucher code control number may still persist in the system despite the voucher code itself being deleted in some embodiments.

After block 1506 the logic may proceed to block 1508. At block 1508 the logic may prohibit voucher code downloads to retailers until the associated product's pre-order and/or release date has been reached. Whether voucher codes are prohibited from download until the pre-order has been reached or until the release date has been reached may be specified by the supplier, such as in a content information list the supplier uploads to the DCS.

From block 1508 the logic may then proceed to block 1510 where the logic may enable retailers to access code restrictions on the DCS so that each retailer may discern, for example, a number of voucher codes assigned to that retailer, the maximum number of voucher codes that retailer may download in a single bulk order, which voucher codes have been deleted/cancelled, and when the voucher codes may still be downloaded by that retailer. The code restrictions may be accessed by a retailer, for example, by logging in to the DCS via a web-based portal and manipulating a UI for the web-based portal to view the foregoing information.

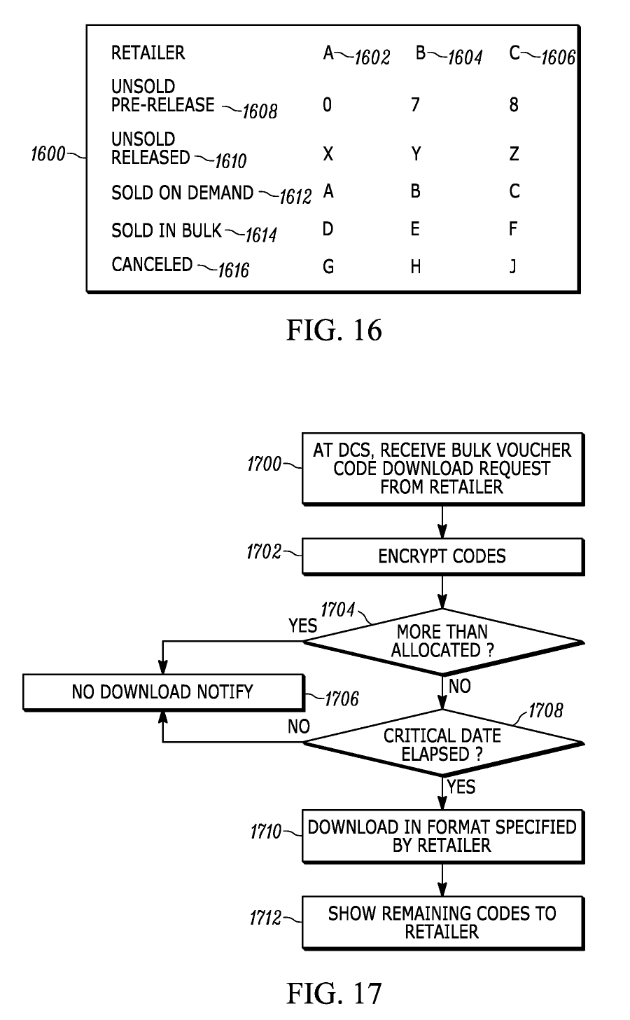

Now in reference to FIG. 16, it is to be understood that a DCS in accordance with present principles may manage, support and track/monitor the status of voucher codes for a particular product. Thus, a UI 1600 may be presented on the display of a supplier's computer system as provided by the DCS when the supplier is logged in via the supplier's computer system. As may be appreciated from FIG. 16, columns 1602, 1604, and 1606 may be provided for respective retailers. Rows 1608, 1610, 1612, 1614, and 1616 may be provided for the following respective voucher code statuses: unsold pre-release, unsold released, sold on-demand, sold in-bulk, and cancelled.

The status of unsold pre-released may be for voucher codes that have not been distributed to a retailer, where a current date is before than the release date of the product. The status of unsold released may be for voucher codes that have not been distributed to a retailer, where a current date is at least the same if not later than the release date of the product. The status of sold on-demand may be for voucher codes that have been distributed to a retailer individually on demand of the retailer, as might be requested through the DCS one-at-a-time as might be needed by the retailer. The status of sold in-bulk may be for plural voucher codes that have been distributed at the same time to a retailer through a bulk request of plural voucher codes. The status of cancelled may be for voucher codes that have been deleted/inactivated by the supplier and that cannot, as a result, be distributed to a retailer even if the voucher code control number may still be looked up.

Accordingly, by accessing the UI 1600 as may be provided by the DCS, the supplier may view numerical quantities for respective voucher codes by status and retailer using the rows 1608-1616 and columns 1602-1606. For example, in order for the supplier to determine how many voucher codes assigned to retailer “B” may be left unsold pre-release, the supplier may access the UI 1600, go to row 1608 and then move to the right until column 1604 is reached to determine that, in this example, retailer “B” has seven voucher codes unsold pre-release.

Now addressing bulk-downloads of voucher codes in accordance with present principles, example logic for conducting bulk downloads is shown in the flow chart of FIG. 17. However, note that the logic of FIG. 17 may also be executed for an on-demand single voucher code download, with appropriate adjustments being made as might be needed for a single voucher code download embodiment.

It is to be understood that the logic of FIG. 17 may be executed by a system of computers in accordance with present principles, such as by a DCS in conjunction with a retailer's computer system. The logic begins at block 1700 where the logic, at the DCS, receives a bulk voucher code download request from a retailer's computer system. The request may be received based on a retailer user using a shopping cart UI associated with the DCS to submit the request. Also, note that in some embodiments such requests are to be approved by a retailer user having an order approval role as described herein before the voucher code request can be submitted to the DCS and/or before the voucher codes can be downloaded as described below.

The logic of FIG. 17 may then move to block 1702 where the logic may, at the DCS, assemble and encrypt a number of codes that complies with the request. The codes may be encrypted using Pretty Good Privacy (PGP) encryption (or another suitable encryption protocol) and a key specific for that particular retailer.

From block 1702 the logic may then proceed to decision diamond 1704. At diamond 1704 the logic may determine whether the bulk-requested amount of voucher codes exceeds an allocated amount/code quota/code threshold for that retailer (e.g., for a given time period and/or per other supplier-defined conditions). An affirmative determination at diamond 1704 may cause the logic to proceed to block 1706 where the logic may disallow the bulk voucher code download and notify the retailer (e.g., via email) that the codes cannot be downloaded in the number requested or that the bulk download being attempted has otherwise failed. However, a negative determination at diamond 1704 may instead cause the logic to proceed to decision diamond 1708.

At diamond 1708 the logic may determine whether a “critical date” has elapsed. The critical date may be, for example, a pre-order date on which the supplier allows voucher codes for a given product to be distributed. The critical date may also be, as another example, a product release date on which the supplier allows voucher codes for a given product to be distributed and redeemed. A negative determination at diamond 1708 may cause the logic to proceed to block 1706 and undertake one or more actions at that block as described above. However, an affirmative determination at diamond 1708 may instead cause the logic to proceed to block 1710.

At block 1710 the logic may permit or facilitate downloading of the voucher codes in bulk in a format requested or specified by the retailer that submitted the request for the codes (e.g., as might be defined when the retailer initially integrates with the DCS). The logic may then move to block 1712 where the logic may show or display (e.g., in the shopping cart UI referenced above) the retailer's remaining code amount/inventory per the supplier's defined code quota for that retailer and/or per the new codes downloaded in bulk.

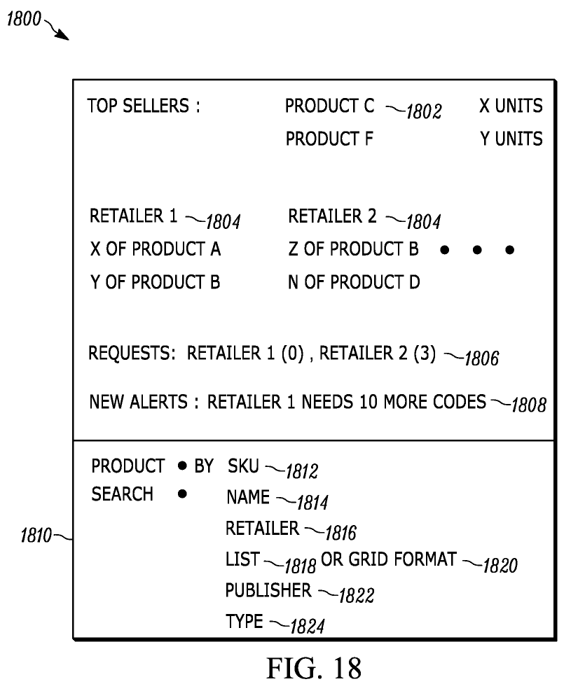

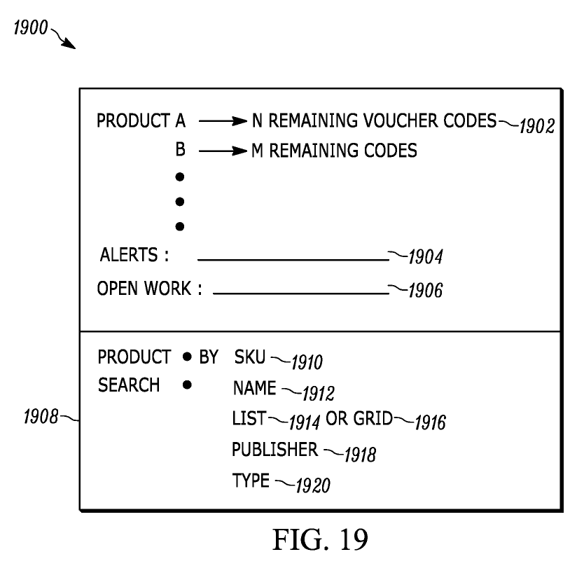

Now discussing landing pages that may be presented responsive to successful login to a digital code server (DCS) in accordance with present principles, FIG. 18 shows an example landing page UI 1800 that may be presented on a display of a supplier computer system based on a successful supplier user login. FIG. 19 shows an example landing page UI 1900 that may be presented on a display of a retailer computer system based on a successful retailer user login.

Beginning first with FIG. 18, the UI 1800 may include information 1802 indicating top-selling/best-selling products and the number of units of each product that have been sold. The UI 1800 may also include information 1804 indicating sales data broken down by retailer, with the information 1804 indicating, for each retailer, a number of units sold for each product the supplier has assigned to that respective retailer. Additionally, the UI 1800 may include information 1806 indicating all pending and/or new voucher code requests from various retailers, with the number of requests being indicated in parenthesis as shown in this example. The UI 1800 may also include information 1808 indicating all alerts or any new alerts (e.g., since the last supplier login). In the example shown, “Retailer 1” is indicated as needing ten more voucher codes.

The UI 1800 may also include a product tab or area 1810 at which a supplier user may search for and/or filter product and voucher code information for presentation by product SKU (based on selection of selector 1812), by product name (based on selection of selector 1814), or by retailer (based on selection of selector 1816). Additionally, selector 1818 may be selected to present the information in list format, while selector 1820 may be selected to present the information in grid format. Selector 1818 is underlined in the example shown in FIG. 18 to denote that selector 1818 has been selected rather than selector 1820.

In addition to the foregoing, in some embodiments a supplier user may search for and/or filter product and voucher code information for presentation by product publisher (based on selection of selector 1822) or by product type (based on selection of selector 1824).

Now describing the UI 1900 shown in FIG. 19, it shows an UI 1900 that may be presented on a display of a retailer computer system based on/responsive to a successful retailer user login. The UI 1900 may include information 1902 indicating product inventory information such as particular numbers of voucher codes currently available to be sold by the retailer for each one of the products the retailer has been authorized to sell, as also indicated in the information 1902. The UI 1900 may also include information 1904 indicating all alerts or any new/open alerts (e.g., since the last retailer login). In the example shown, no retailer alerts are outstanding. Still further, the UI 1900 may include information 1906 indicating open work for the retailer to complete, such as product change acknowledgement as described herein.

The UI 1900 may also include a product tab or area 1908 at which a retailer user may search for and/or filter product and voucher code information for presentation by product SKU (based on selection of selector 1910) or by product name (based on selection of selector 1912). Additionally, selector 1914 may be selected to present the information in list format, while selector 1916 may be selected to present the information in grid format. In addition to the foregoing, in some embodiments a retailer user may search for and/or filter product and voucher code information for presentation by product publisher (based on selection of selector 1918) or by product type (based on selection of selector 1920).

Moving on from FIG. 19, it is to be understood in accordance with present principles that many if not all DCS pages and UIs may use supplier branding and logos. Additionally, email alerts and lists as disclosed herein may also use supplier branding and logos. Reports that are generated as disclosed herein may also use supplier branding and logos.

It will be appreciated that whilst present principals have been described with reference to some example embodiments, these are not intended to be limiting, and that various alternative arrangements may be used to implement the subject matter claimed herein.

What is claimed is:

1. A system, comprising:
at least one digital code server (DCS) comprising at least one server processor and at least one server storage having instructions executable by the server processor;
at least one supplier computer system comprising at least one supplier processor and at least one supplier storage having instructions executable by the supplier processor; and
at least one retailer computer system comprising at least one retailer processor and at least one retailer storage having instructions executable by the retailer processor, wherein
the supplier processor accessing the instructions on the supplier storage is configured to upload code information to the DCS, the code information including information categorized by retailer identity and product type;
the retailer processor accessing the instructions on the retailer storage is configured to access the code information from the DCS and to provide codes according to the code information to buyers of products, the products requiring input of respective codes by buyers to be fully enabled.

2. The system of claim 1, wherein the code information includes, for each code, a product identification to which the code applies, a retailer to whom the code applies.

3. The system of claim 1, wherein the supplier processor accessing the instructions on the supplier storage is configured to upload to the DCS, for at least some codes, a standard release date and a pre-order release date.

4. The system of claim 3, wherein the server processor accessing the instructions on the server storage is configured to prevent downloading, to the retailer computer system, at least one code prior to the respective standard release date and/or pre-order release date of the respective code.

5. The system of claim 1, wherein the retailer processor accessing the instructions on the retailer storage is configured to present, on at least one display of the retailer computer system, at least one user interface (UI) presenting plural product identifications and respective code data for at least some of the respective product identifications.

6. The system of claim 1, wherein the server processor accessing the instructions on the server storage is configured to:
access information related to sales velocity pertaining to a first retailer and a first product;
access information related to a threshold pertaining to the first retailer and the first product; and
determine, based at least in part on the sales velocity and threshold, whether to send an alert message to at least the supplier computer system.

7. The system of claim 1, wherein the supplier processor accessing the instructions on the supplier storage is configured to upload to the DCS at least one product update;
the retailer processor accessing the instructions on the retailer storage being configured to:
download from the DCS the product update; and
implement the product update on a respective product within a supplier-defined period.

8. The system of claim 1, wherein the retailer processor accessing the instructions on the retailer storage is configured to upload to the DCS at least one request for additional codes pertaining to at least a first product, the server processor accessing the instructions on the server storage being configured to provide the request to the supplier computer system, the supplier processor accessing the instructions on the supplier storage being configured to upload to the DCS codes according to the request.

9. The system of claim 1, wherein the supplier processor accessing the instructions on the supplier storage is configured to present, on at least one display of the supplier computer system, at least one user interface (UI) comprising:
for at least one retailer, indication of unsold codes associated with pre-release products, indication of unsold codes associated with released products, indication of codes sold on demand, indication of codes sold in bulk, and indication of canceled codes.

10. The system of claim 1, wherein the server processor accessing the instructions on the server storage is configured to:
receive a request from the retailer computer system for a bulk code download;
determine whether the request exceeds an allocated number of codes;
responsive to the request exceeding the allocated number of codes, not download any codes in response to the request to the retailer computer system.

11. The system of claim 10, wherein the server processor accessing the instructions on the server storage is configured to:
determine whether at least one critical date pertaining to the request is satisfied; and
responsive to determining that the critical date pertaining to the request is not satisfied, not satisfy the request.

12. The system of claim 11, wherein the server processor accessing the instructions on the server storage is configured to:
download plural codes to satisfy the request responsive to the request not exceeding the allocated number of codes, and responsive to determining that the critical date pertaining to the request is satisfied.

13. The system of claim 1, wherein the supplier processor accessing the instructions on the supplier storage is configured to present, on at least one display of the supplier computer system, at least one user interface (UI) comprising:
an indication of at least one top-selling product;
an indication of product sales by at least first and second retailers;
an indication of at least one request from at least one retailer computer system; and
at least one product tab region operable to search for product sales information using one or more of plural filters.

14. A method, comprising:
receiving, at a digital code server (DCS) and from a supplier computer, code information, the code information including information associated with retailer identity and product type;
receiving, at the DCS and from a retailer computer, a request for at least a first portion of the code information;
determining, at the DCS, whether to provide the first portion to the retailer computer; and
responsive to determining to provide the first portion, providing the first portion to the retailer computer.

15. The method of claim 14, wherein the determining whether to provide the first portion to the retailer computer is based at least in part on whether a code quota has been reached for a retailer associated with the retailer computer.

16. The method of claim 14, wherein at least one code indicated in the first portion is useable to access a first product associated with the at least one code, and wherein the request is for the at least one code.

17. The method of claim 14, wherein plural codes are indicated in the first portion, the plural codes each being useable to access a first product associated with the plural codes, the method comprising:
receiving the plural codes at the DCS in at least one of comma-separated value (CSV) format and a spreadsheet format.

18. At least one device, comprising:
at least one processor; and
storage accessible to the at least one processor and bearing instructions executable by the at least one processor to:
receive, from a supplier, product code information, the product code information including at least one product code and including information associated with a retailer authorized to sell the at least one product code;
store the product code information; and
allocate the at least one product code to the retailer.

19. The device of claim 18, wherein the instructions are executable by the at least one processor to:
receive, from the supplier, an update to the product code information; and
provide an alert to the retailer indicating the update.

20. The device of claim 18, wherein the instructions are executable by the at least one processor to:
generate a daily report indicating whether the at least one product code has been sold; and
make the daily report available to the supplier.
